(19) United States
(12) Patent Application Publication
(10) Pub. No.: US 2012/0151542 A1
(43) Pub. Date: Jun. 14, 2012

(54) Bandwidth Sharing and Statistical Multiplexing between Video and Data Streams

(75) Inventors: Alon Shafrir, Kfar saba (IL); Amit Eschet, Tivan (IL)

(73) Assignee: ARRIS GROUP, INC., Suwanee, GA (US)

(21) Appl. No.: 13/324,612

(22) Filed: Dec. 13, 2011

Related U.S. Application Data
(60) Provisional application No. 61/422,231, filed on Dec. 13, 2010.

(51) Int. Cl. H04N 21/643

(52) U.S. Cl. 725/109

(57) ABSTRACT

Systems and methods can provide bandwidth sharing and statistical multiplexing between video and data streams. In some implementations, such systems and methods can associate and allocate input data streams to enable prioritization logic and parameters. Such systems and methods can multiplex on a per-packet basis and/or over a transmission interval T. The multiplexing function can then combines with varying optimization methods such as bandwidth sharing, statistical multiplexing, channel bonding, and rate shaping, thereby increasing efficiency while maintaining quality of service (QoS) and quality of experience (QoE).

### CROSS-REFERENCE

This disclosure claims priority as a non-provisional of U.S. Provisional Patent Application Ser. No. 61/422,231, entitled “BANDWIDTH SHARING AND STATISTICAL MULTIPLEXING BETWEEN VIDEO AND DATA STREAMS,” filed on Dec. 13, 2010, the entire disclosure of which is hereby incorporated by reference in its entirety.

### TECHNICAL FIELD

This disclosure relates to bandwidth sharing and statistical multiplexing between video and data streams in broadband devices.

### BACKGROUND

The Data-Over-Cable Service Interface Specification (DOCSIS) was established by cable television network operators to facilitate transporting data packets, primarily internet packets, over existing community antenna television (CATV) networks. In addition to transporting data packets, as well as television content signals over a CATV network, multiple services operators (MSO) also use their CATV network infrastructure for carrying voice, video on demand (VoD) and video conferencing packet signals, among other types.

For example, content in CATV networks is delivered through downstream channels using mechanisms, such as, for example, Radio Frequency Quadrature Amplitude Modulator, ITU-T J.83, among many others. The network infrastructure consists of multiple such channels shared by multiple clients. Each downstream channel can carry a constant rate of bits per second and has the cost of buying, setting, and maintaining the relevant infrastructure equipment. Typically, a stream is assigned to a specific channel (the same channel can carry additional streams) and a client-receiver is tuned to that specific channel.

Traditionally, there are two types of receivers that can tune to a downstream channel. One type of receiver is a legacy video set-top box (STB) which can tune to one downstream channel, receives MPEG transport streams and displays a specific video stream. This content can be referred to as “video services.” Another type of receiver is a cable modem (CM), which can tune to one or more Data over Cable Systems Interface Specification (DOCSIS) downstream channel(s), receives a DOCSIS stream carrying IP packets and forwards the IP packets to other devices locally connected to the CM (such as a personal-computer or an IP-STB). This content can be referred to as “data services.” It should be understood that “data” in this context can carry video information but is considered data since the video is delivered to the client-device as IP packets.

Today, downstream channels are configured to be DOCSIS channels or MPEG channels. Hence, video services are carried only over MPEG channels and data services are carried only over DOCSIS channels. However, there is an inherent inefficiency to segregating services by delivering video and data services on separate downstream channels. This inefficiency means operators deliver significantly less content than the theoretical limit of the downstream channel infrastructure. This bandwidth (BW) inefficiency problem is due to many independent issues, all contributing to underutilization of network BW.

These issues include, but are not limited to, the following: inefficiency of constant bit-rate (CBR) allocation, granularity issues when packing video stream channels, inefficiency due to partition to video-pool and data-pool, transforming video streams using bonded flows, optimizing packet queues for channel bonding with presence of legacy CMs, statistical multiplexing and/or rate shaping for an MPEG channel, delivering data services in MPEG format, and minimizing video services, among others.

### BRIEF DESCRIPTION OF THE DRAWINGS

FIG. 1 is a block diagram illustrating a prior art example network environment.

FIG. 2 is a block diagram illustrating an example network environment operable to perform bandwidth sharing and statistical multiplexing between video and data streams.

FIGS. 3A-B are block diagrams illustrating an example bandwidth usage for 12 downstream channels operable to perform bandwidth sharing and statistical multiplexing between video and data streams.

FIG. 4 is a flowchart illustrating an example process of input processing applied per-received input packet operable to perform bandwidth sharing and statistical multiplexing between video and data streams.

FIG. 5 is a flowchart illustrating an example process of processing applied per-transmission over time interval T operable to perform bandwidth sharing and statistical multiplexing between video and data streams.

FIG. 6 is a block diagram of a broadband communications device operable to perform bandwidth sharing and statistical multiplexing between video and data streams.

### DETAILED DESCRIPTION

In some implementations of this disclosure, systems and methods can operate to perform intra-channel bandwidth sharing between different types of services. In some implementations, DOCSIS and MPEG streams can be delivered on the same downstream channel. This bandwidth sharing can enable a pool of channels to serve both data and video services, thus improving efficiency. In addition, data and video can be bonded across several DOCSIS/MPEG shared channels. In some implementations, utilizing a known method of DOCSIS channel bonding together with intra-channel sharing can create the equivalent of one downstream channel having a bandwidth equal to the sum of bandwidths of multiple bonded downstream channels.

In some implementations of this disclosure, systems and methods can also operate to prioritize variable bit-rate (VBR) delivery. In some implementations, utilizing a lower quality of service (QoS) requirement for some data services together with intra-channel sharing can enable low complexity VBR delivery of streams on a constant bit rate downstream channel. It should be understood that if there are more bits awaiting transmission than can be sent instantaneously, a multiplexer can buffer those bits, delaying them until bandwidth is available. When this delay exceeds the tolerance of the receiver, the quality of user experience (QoE) can be diminished.

For example, given a collection of services with a delay-tolerance T; a system that can ensure with high probability that per interval of duration T, the total amount of bits to send fits the channel capacity in the same interval can ensure a desired QoE. Systems can ensure such high probability by using safety margins that accommodate for the variability between an average bit rate and a maximal bit rate of services. The prioritized VBR delivery can take a set of input services with various delay-tolerances and deliver them such that an allocation function can view all services as having delay-tolerance of the most robust type of services. Larger delay-tolerance can reduce the safety margins leading to better efficiency. This facilitates more services to be delivered on the same channel with the same QoE.

In some implementations, better efficiency can be accomplished by larger virtual-channels, consisting of several channels. For example, larger channels allow the statistics of more independent services to be combined resulting in better statistics. A bonded-channel of N channels can deliver N times more services. The safety margin can be proportional to variability of the services carried (e.g., 2 standard deviations) and when N times more services are summed, the percentage of total BW used for a safety margin becomes smaller by a factor of the order of the square root of N.

For example, a channel carrying VBR services may entail a 20% margin between an average bit rate and channel capacity to accommodate for peaks and ensure desired QoE. When bonding 4 such channels, similar QoE statistics can be provided by supporting only 10% variability above the average, thus increasing utilization from 80% to 90% over all 4 channels.

In some implementations, utilizing data and video channel bonding, together with known methods of statistical-multiplexing and/or rate-shaping methods can achieve efficient delivery. In still further implementations, utilizing data and video channel bonding together with prioritized VBR delivery can achieve an efficient delivery that requires lower computational-complexity but has comparable QoS characteristics.

In some implementations, a method can be provided to include forming a bonded channel spanning multiple QAM channels similarly to bonded channels defined in DOCSIS DRFI but with the bonded channel carrying both video programs (per ITU H.222) and data services. This enables solving the granularity issue as well as facilitating better utilization of the bandwidth when carrying VBR traffic for both video and data services. In this case, the multiplexer is responsible for N (e.g. 4) QAM channels in parallel and multiplexes a set of inputs onto the output channels.

Since legacy STBs do not support bonded channels, each video input program to be viewed by legacy STBs should be allocated to a single QAM channel. In parallel, the multiplexer can treat all data input traffic as inputs to one larger channel having the BW of all QAM channels belonging to the bonded channel. When multiplexing data inputs, it can work in a granularity of an IP packet, and multiplex each data-IP-packet onto a consecutive set of data-transport packets (TSPs) on a specific QAM channel. Each data-IP-packet can be multiplexed onto any of the QAM channels in that bonded channel, regardless of other packets belonging to same input service.

For example, an implementation can work in time intervals: first serve all video inputs to be transmitted on any of the QAM channels in that interval, treat all remaining BW (unused transport packets) in the QAMs making up that bonded channel as one channel and multiplex data-IP-packets onto it, satisfying the granularity mentioned above. In this part, the multiplexer ignores already-used data packets of video PIDs and a single data-IP-packet can be interleaved with such packets.

In the context of VBR inputs, the multiplexing method should be extended if the upper layers of the service expect the transmission path to deliver data in the order sent, DOCSIS encapsulation of the data IP packets can include sequence numbers indicating original order of packets per DOCSIS so that the CM can reproduce the original order even if reordering has occurred when transmitting on separate QAM channels. In case the upper layer is robust to IP-packets-reordering (e.g. a TCP based service), this preference can be relaxed.

In additional implementations, utilizing data and video channel bonding together with prioritized VBR delivery can achieve an efficient delivery that requires lower computational-complexity but has comparable QoS effects. For example, since channel bonding and prioritized-VBR delivery are not aligned in the simplest multiplexing schema more advanced multiplexing method can be applied. One such method can be aware that some services are bound to a specific sub-channel (thus getting higher priority in that channel) and handling cases where some services deserve a higher priority in the overall bonded channel.

In some implementations, the following example method that can satisfy these provisions: (1) Assign quota and priority per input in each channel and in each time interval; (2) Derive a priority from ability to further shift transmission time of the relevant data; (3) When a later-served input cannot be served well, lower-priority quotas can be updated (delaying data to next interval) as long as it does not mean the priority will become higher; (4) In a later phase, quotas can be translated to actual placement of actual packets and at this point, the prioritization choices result in efficient data distribution to each channel and maximizing QoE in all services.

In other implementations, utilizing data and video channel bonding together with prioritized VBR delivery and known methods of statistical multiplexing can achieve an efficient delivery that requires medium computational complexity and a reduced effect on QoS compared to other implementations.

In some implementations, a new scheme of overlapping bonded channels can provide efficient bandwidth sharing across all included downstream channels. This scheme improves efficiency by sharing bandwidth beyond the extent provided by one bonded channel of a few downstream channels (a single bonded channel is limited to include a few downstream channels that can be received simultaneously by a receiver device).

In other implementations, one may consider optimizing QoE by reallocating services between downstream channels whenever reconsidering allocation of new services to downstream channels. In order to maximize overall QoE, it may be desired to relocate existing, flowing streams from the channel they were assigned to a different channel. It should be understood that this can be done with little or no impact on QoE for the relocated streams as further described in below.

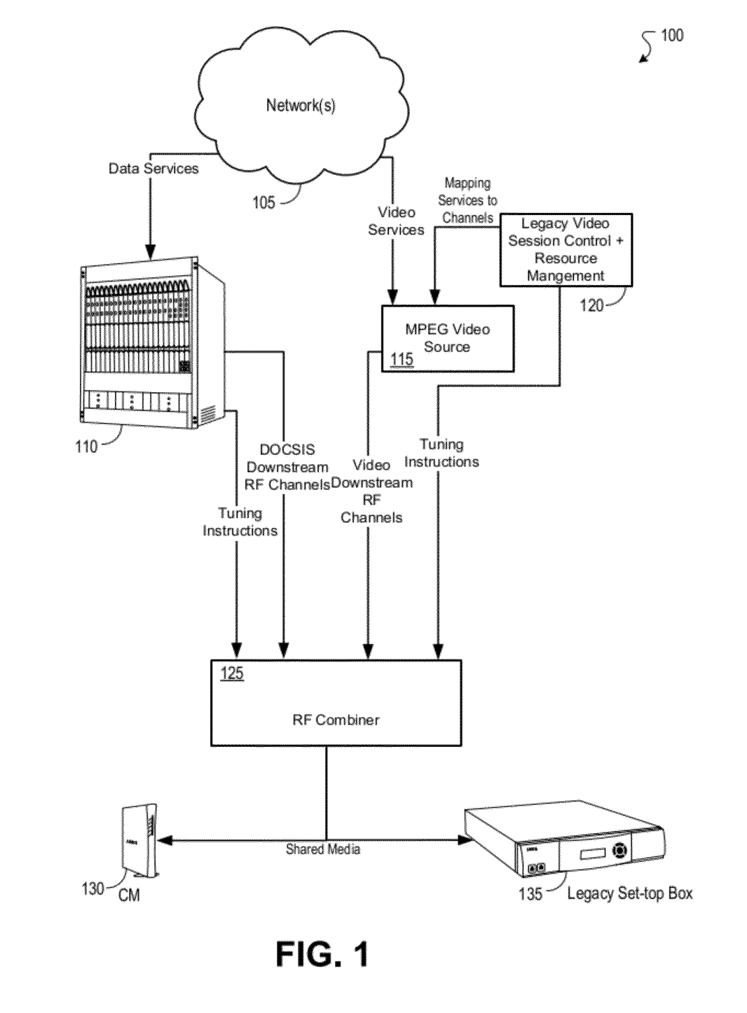

FIG. 1 is a block diagram illustrating a prior art example network environment. In some implementations, a network 105 connection can be a data and/or video source to a headend 110 and/or MPEG video source 115. The headend 110 can be a device such as, for example, a cable modem termination system (CMTS). The MPEG video source 115 can be a device such as, for example, an edge QAM (EQAM). Traditionally, a separate module, legacy video session control+resource management module 120, provides mapping services to the MPEG video source 115.

DOCSIS downstream data from the headend 110 is combined with video downstream RF channels in an RF combiner 125. The RF combiner 125 passes the data and video over a shared media to the CM 130 and legacy set-top box 135. The shared media can be a connected medium such as, for example, a hybrid-fiber coaxial (HFC) connection. In prior art systems, DOCSIS data stream from the headend 110 is destined for the CM 130 and the MPEG video from the MPEG video source 115 is destined for the legacy STB 135. Moreover, the headend 110 can send tuning instructions to the CM 130. Correspondingly, the legacy video session control 120 can send tuning instructions to the legacy STB 135.

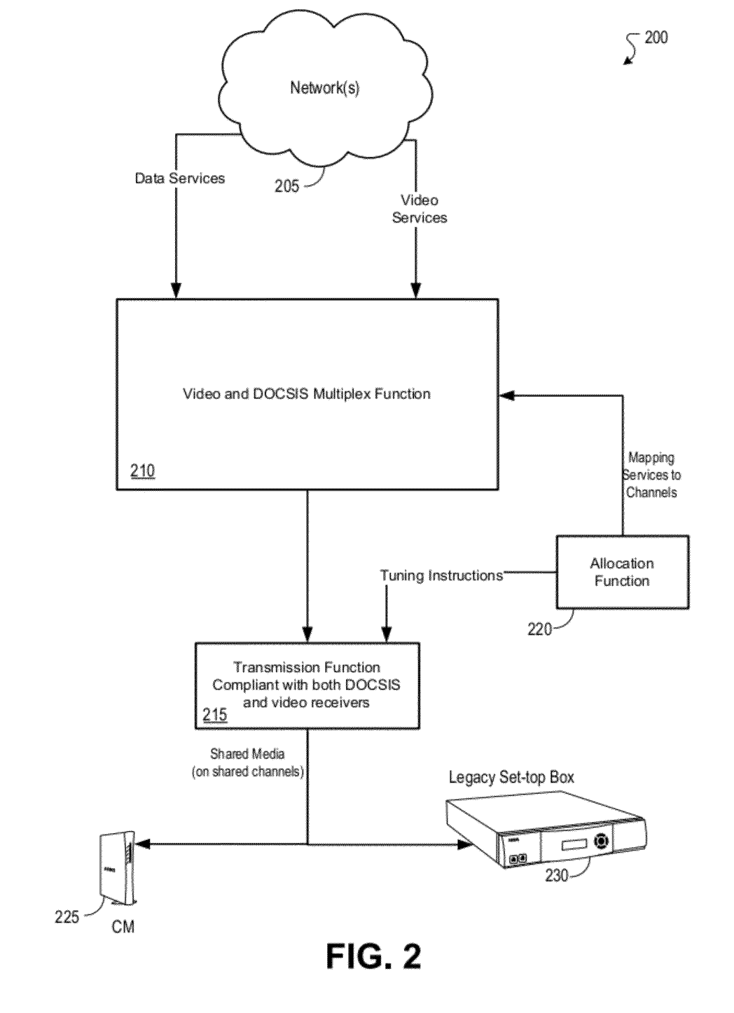

FIG. 2 is a block diagram illustrating an example network environment operable to perform bandwidth sharing and statistical multiplexing between video and data streams. In some implementations, a network 205 connection can originate a data and/or video source to a video and DOCSIS multiplex function 210. The DOCSIS multiplex function 210 can be a broadband device such as, for example, a CMTS. The DOCSIS multiplex function 210, in conjunction with the transmission function 215 and allocation function 220, can be operable to perform bandwidth sharing and statistical multiplexing between video and data streams.

Following the multiplex function, data and video can be transmitted via the transmission function 215 using information from the allocation function 220. The data and video can be destined for a CM 225 or a legacy STB 230. It should be understood that the DOCSIS multiplex function 210, transmission function 215, and/or the allocation function 220 can reside inside or apart from the headend device (e.g., CMTS 110 of FIG. 1). Moreover, the allocation function 220 also sends tuning instructions to the CM 225 and the legacy STB 230. In some implementations, the set of QAM channels used in the bonded channel can be communicated to and/or coordinated with the CM 225 so that the CM 225 can be tuned to all QAM channels, which carry data for the CM's provisioned services.

In alternative implementations, the allocation of inputs to transmission channels can be designed to maximize the benefits of channel bonding. In that sense, the granularity issues can be seen in requirements to allocate legacy-video streams in a single channel as well as inability to transmit a whole data-IP-packet on a single channel in a given interval when insufficient is left on the channel. To lessen both issues, the allocation method will level the bandwidth left for data services in each transmission channel. This is true both for channels within a bonded channel and when selecting between bonded channels.

The DOCSIS multiplex function 210, transmission function 215, and allocation function 220 can be provided by a system includes a multiplexer and a J.83 QAM transmitter, which can receive two types of inputs: ITU H.222 transport streams and DOCSIS encapsulated data packets. In some implementations, these in turn can be implemented in the same device or separate device as the headend and/or other networked device. In some implementations, all inputs are multiplexed together to one bit-stream having a constant-bit-rate. The output bit stream can be divided to transport-packets per ITU H.222 with time division multiplexing of such transport packets. This bit stream can then be transmitted. For example, the following functions can ensure the transmitted signal is considered compliant by two types of receivers: STBs looking for an MPTS (Multiple-program-transport-stream) per ITU H.222 spec. transmitted per ITU J.83 spec and cable modems looking for a DOCSIS Downstream per DOCSIS DRFI spec.

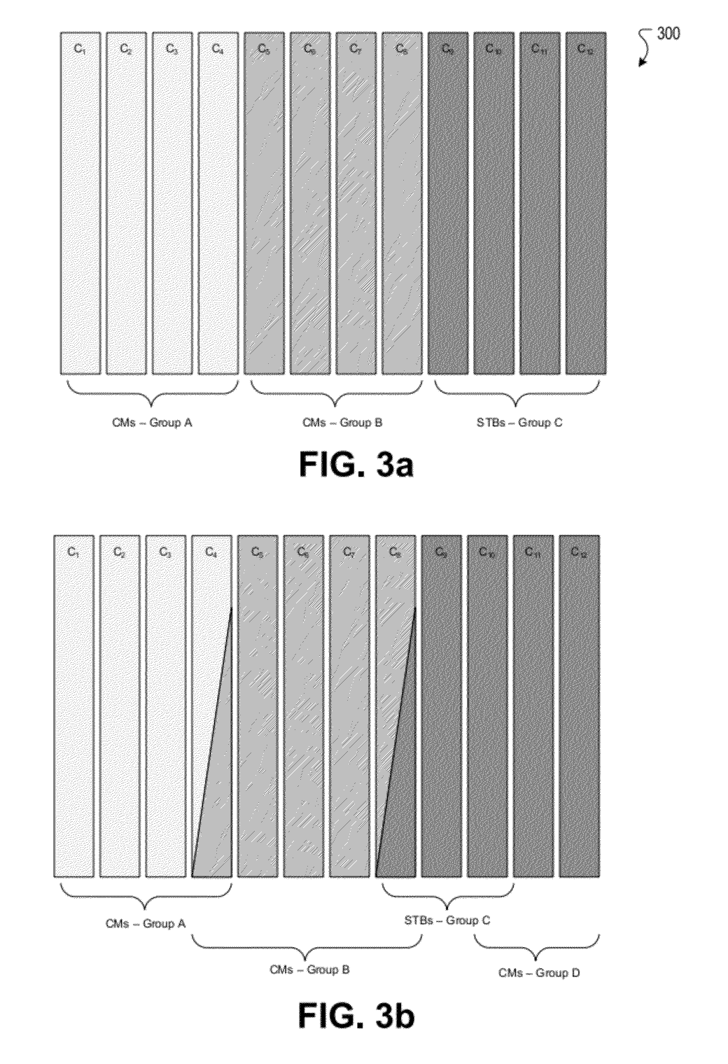

FIGS. 3A-B are block diagrams illustrating an example bandwidth usage for 12 downstream channels operable to perform bandwidth sharing and statistical multiplexing between video and data streams. FIG. 3A displays a traditional, unshared group of segregated data and video channels. The lack of BW sharing between data and video within a channel limits the number of groups (e.g., CMs—Group A, CMs—Group B, STBs—Group C) and thereby lowers the data and video stream efficiency. FIG. 3B displays multiplexed channels that can be bonded with data and/or video. The increased efficiency affords an increase of an additional group within the 12 channels (e.g., CMs—Group D). In the displayed 12 channels, each CM is capable of tuning to 4 adjacent channels. Instead of partitioning to 3 disjoint bonded-channels of 4 channels each, this function facilitates partitioning to 4 overlapping-bonded-channels. Overlapping means some physical channels (e.g., C₄ of FIG. 3B) can be shared by two bonded-channels. The STBs of group C are unaffected by this partitioning.

In some implementations, given a set of channels C₁ . . . C_{N} and receivers capable of tuning to K channels where MK=N. Instead of partitioning to M groups of K channels, some implementations may partition to more groups (e.g. M*120%) where on average, each group can have BW equivalent to K/120% somewhere within K channels that the relevant CMs are tuned to. This can be applied when receiver limitation is other than “K adjacent channels” and/or be applied to subsets of the channels.

In some implementations, an allocation function can: (1) instruct a receiver to tune to the set of channels of the group that CM was assigned; (2) signal to a multiplex function the mapping of channels to bonded-channels and signal for each channel if it is: (i) exclusively owned by one bonded channel; (ii) shared between bonded channels A, B where bonded-channel A takes priority over bonded-channel B when it comes to this channel; (3) Map data services to the relevant bonded-channel; (4) Map legacy video services to channels similarly to what is described for the relevant method but prioritizing their allocation to a channel being exclusively owned by a certain bonded channel and only if impossible, allocate a legacy video service to a channel shared by 2 bonded channels; (5) If adding delivery of a new video service results in over-allocation of the associated bonded channel any affected CMs along with all their services can be redirected to a different bonded channel.

In other implementations, multiplexing logic can be modified so that: (1) for each bonded channel X, for each multiplexing interval: (i) unallocated bandwidth of QAM channels being exclusively owned by that bonded channel can be used first for all data services of that bonded channel; (ii) Only afterwards, will the multiplexor use bandwidth from channels shared with another bonded channel Y and for which X has priority over Y, applying the video and data multiplexing method relevant for this channel. For channels shared with another bonded-channel Y where Y has priority over X, bandwidth in these channels can be used for traffic of bonded-channel X only after fulfilling all bandwidth requirements of bonded-channel Y for the same time interval.

It should be understood that if bandwidth is momentarily short in group A, one implementation of the multiplex method would allow group A to use bandwidth shared with group B. Group B can then use bandwidth shared with group C and so forth. Any group can “borrow” BW from any other group in the set as long as “borrowed BW” is less than the BW of the shared BW between each two adjacent groups. The fact that any group can “borrow BW” from any other group actually enables dynamic BW sharing between all groups resulting in the equivalent of one combined bonded channel in terms of BW efficiency provided that the allocation method guarantees that “imbalance” between groups can be up to the amount of shared-BW between 2 adjacent groups.

In still further implementations, an improvement can be performed by adding an online feedback loop where: (1) The multiplex function reports to the allocation function on statistics of BW usage in each channel by each group; (2) The allocation function considers reallocating services and/or changing mappings to avoid poor QoE for one group while there is unutilized BW in another. Note that unlike with disjoint bonded channels, adding an online feedback look can be desirable when BW-utilization-difference between groups grows beyond a channel capacity since up to 1 and in some cases 2 channels' capacity is automatically handled by the multiplex function when applying the usage method of shared channels described above. This improvement enables the allocation function to fix past mistakes, which resulted in a high imbalance between groups. This improvement is expected to happen infrequently and can therefore be implemented with low frequency reporting and monitoring suitable for the interface between the allocation function and the multiplex function.

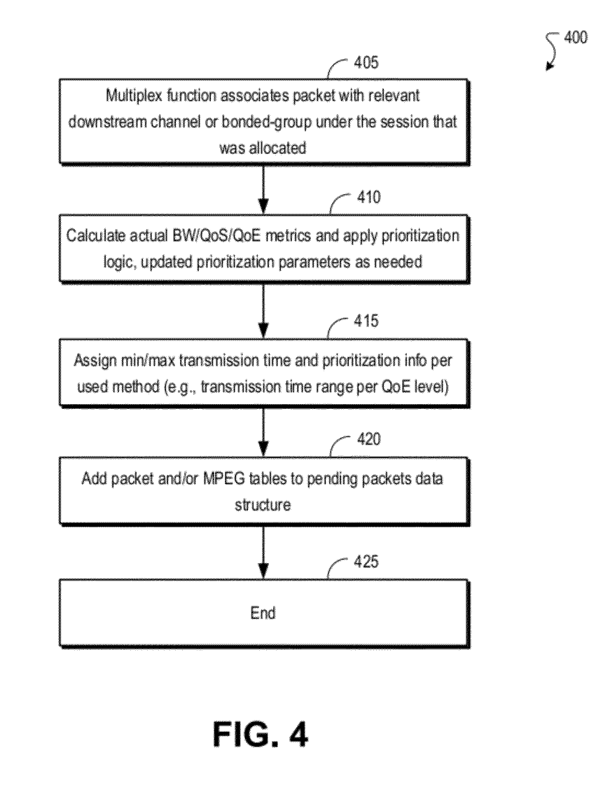

FIG. 4 is a flowchart illustrating an example process for input processing applied per-received input packet operable to perform bandwidth sharing and statistical multiplexing between video and data streams. The process 400 begins at stage 405 when the multiplex function associates a packet with a relevant downstream channel or bonded group under an allocated session. The video and DOCSIS multiplex function (e.g., video and DOCSIS multiplex function 210 of FIG. 2) can associate the packet with a relevant downstream channel. In other implementations, the allocation function (e.g., allocation function 220 of FIG. 2) and/or the transmission function (e.g., transmission function 215 of FIG. 2) can allocate the packet with a relevant downstream channel.

At stage 410, a calculation of BW/QoS/QoE metrics and application of prioritization logic and updated prioritization parameters occurs. The calculation can occur at the video and DOCSIS multiplex function (e.g., video and DOCSIS multiplex function 210 of FIG. 2). In alternative implementations, the calculation can be performed by an allocation function (e.g., allocation function 220 of FIG. 2) and/or the transmission function (e.g., transmission function 215 of FIG. 2). In some implementations, the calculation can incorporate one or more prioritization parameters.

At stage 415, each packet is assigned a minimum and maximum transmission time and prioritization info based on the method used. The assignment can be performed, for example, by the video and DOCSIS multiplex function (e.g., video and DOCSIS multiplex function 210 of FIG. 2), the allocation function (e.g., allocation function 220 of FIG. 2), and/or the transmission function (e.g., transmission function 215 of FIG. 2). In some implementations, the user method can allocate, for example, a transmission time range per QoE level.

At stage 420, the packet and/or MPEG tables are added to a pending packet's data structure. The addition can be performed, for example, by the video and DOCSIS multiplex function (e.g., video and DOCSIS multiplex function 210 of FIG. 2). In other implementations, the addition can be performed by an allocation function (e.g., allocation function 220 of FIG. 2) and/or the transmission function (e.g., transmission function 215 of FIG. 2). The process ends at state 425.

In some implementations, the functions in the FIG. 4 flowchart can include a time division multiplexing (TDM) method and can reflect input timing, Tables and PID handling of the multiplex, and actual transmission. In some implementations, a TDM method can include instructions that the multiplexer can maintain a time base calculation per input stream, and calculate for each piece of data in the input the most suitable time for its transmission, which may reflect input timing. Since the multiplexer cannot avoid some granularity in the output stream and since multiple pieces of input data can be transmitted at once across the multiple QAM channels of the bonded channel, some data may be transmitted slightly before or after its due time. Such cases may involve additional steps such as: (1) timing-sensitive data for which timestamps cannot be adjusted due to unsupported formats and/or encryption can be given highest multiplexing priority to minimize transmission time changes; (2) For inputs being ITU H.222, multiplexer can update PCR values to reflect the change in transmission time in terms of input time-base; (3) For inputs being DOCSIS encapsulated, the multiplexer can update timestamps on SYNC messages to reflect actual transmission time in terms of input time-base; (4) At times where there is no data to send, a NULL transport-packet per ITU H.222 can be transmitted.

In some implementations, tables and PID handling of the multiplex can be performed by the multiplexing function. The multiplexer can apply common practice for handling PSI and PID-numbers for multiplexing ITU H.222 streams into MPTS. This can result in PID translation that avoids collisions and in matching PAT and PMT tables where some of these tables can be considered as a separate input for the TDM process. In addition: (1) the multiplexer must avoid usage of PID 0x1FFE as this PID is to be used by DOCSIS traffic; (2) all DOCSIS data must be sent per DOCSIS DRFI in transport-packets having PID=0x1FFE (denoted hereafter data-TSPs); and (3) the multiplexer can create/update tables such that appearance of transport packets with PID 0x1FFE is considered compliant. For example, the multiplexer can create an additional program entry in the PAT, pointing to an additional PMT which the multiplexer creates. This additional PMT can include one elementary stream entry specifying PID 0x1FFE with a stream type signaling private data, for example O×FE. PCR_PID in PMT should be set to 0x1FFF to signal PCR is not used.

In some implementations, a Transmission Bit stream can be transmitted over RF signal per J.83 with the following modifications: (i) transmission should be limited to either 64-QAM or 256-QAM to comply with both receiver types; and (ii) symbol rate can be as specified by DOCSIS DRFI, within the tolerated symbol rate range as specified by J.83 and for compliance with DOCSIS Cable-Modems. Where DOCSIS downstream synchronization is preferred, a symbol rate can be generated by the N/M ratio, meeting symbol rate requirements of DOCSIS DRFI where the reference clock is an externally provided DOCSIS Master clock. (iii) In case of transmission per ITU J.83 Annex B and in case interoperability is needed with older legacy STBs compliant with ITU J.83 Annex B level 1 only, interleaving mode can be set to (I=128, J=1) per J.83 Annex B to ensure interoperability with such receivers. (iv) If interference with analog channels is relevant, transmission power level, MER, and out of band noise can comply with DOCSIS DRFI.

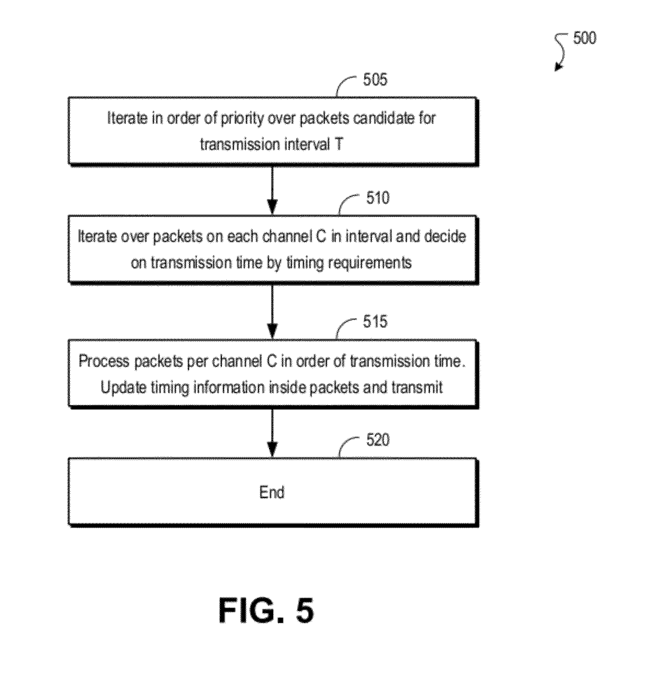

FIG. 5 is a flowchart illustrating an example process of processing applied per-transmission over time interval T operable to perform bandwidth sharing and statistical multiplexing between video and data streams. The process 500 begins at stage 505 when, for a transmission interval T, an order of priority is established over a collection of candidate packets. The order can be established by the video and DOCSIS multiplex function (e.g., video and DOCSIS multiplex function 210 of FIG. 2), allocation function (e.g., allocation function 220 of FIG. 2), and/or the transmission function (e.g., transmission function 215 of FIG. 2).

At stage 510, the group of packets is iterated over to order for transmission on each channel C in intervals based on transmission time and timing requirements. The transmission can be performed by the video and DOCSIS multiplex function (e.g., video and DOCSIS multiplex function 210 of FIG. 2). In alternative implementations, the transmission ordering can be performed by an allocation function (e.g., allocation function 220 of FIG. 2) and/or the transmission function (e.g., transmission function 215 of FIG. 2).

At stage 515, the packets are processed per channel C in order of transmission time, with timing information and transmit times updated inside each packet. The processing can occur at the video and DOCSIS multiplex function (e.g., video and DOCSIS multiplex function 210 of FIG. 2), allocation function (e.g., allocation function 220 of FIG. 2), and/or the transmission function (e.g., transmission function 215 of FIG. 2). The process 500 ends at stage 520.

In some implementations, a method allows transmitting VBR streams in a way improving the channel efficiency with low complexity. The essence is to exploit the differences in delay-tolerance of the different services, such as when mixing data-services with video services. The outcome is a more efficient channel that can carry more services and still maintain an equivalent QoE compared to CBR or non-prioritized-VBR delivery. Alternatively, it can carry the same set of services but provide a better QoE. The following is a multiplexing method and allocation method: prioritize the input streams whose transmission-time-sensitivity is highest. This can be done by statically assigning each input service a priority according to its timing sensitivity and processing inputs per this priority order. For example, a low delay audio voice service can typically be given a high priority. Note that this sensitivity should be considered having incorporated the timing-fields-re-stamping capabilities of the multiplexer for this stream (e.g. PCR re-stamping).

In other implementations, a possible extension is to dynamically calculate the sensitivity (and derived priority) of each input stream. A simple method for dynamic prioritization is to consider sensitivity to additional time shifts, given current situation. For example, consider a service that is robust to delays up to 50 msec, then assume that there is currently a delay of packets by 40 msec. That service's tolerance for additional delay is 10 msec. A more advanced method is to extend the model of QoE-impact of a service. Introducing dynamic calculation allows better models where each service has a function translating current situation to amount of impact on QoE. This function can be very simple or very complex according to specific design choices of the solution. For example, using two delay thresholds, e.g., modeling QoE as intact when delay is below A, expecting “low frequency of mild QoE degradation” when delay is between A and B and expecting “severe QoE degradation” when delay is above B.

In another example, the function can use a continuous formula to translate delay to a QoE metric. In still further examples, the function can include additional statistics besides delay in the model. Statistics can include frequency of high-delay events in the past X seconds or BW allocated to this service in the past X seconds. The latter is specifically suitable for services that have an upper-layer mechanisms that independently sense how much BW the client is actually getting at that point in time and adapts the content to match this BW (e.g. Adaptive video streaming). A possible implementation can use signaling declaring the tradeoffs between BW/delay and QoE in real time to feed such decisions without requiring heavy processing in the multiplexing device.

It should be understood that, in the methods described, the frequency of re-calculating priorities (and hence prioritization accuracy) can vary and is a system design choice. There is a tradeoff here between optimality and computational complexity: one extreme is to re-calculate priority per TSP. On the other extreme, the calculation can be made every hour according to average or maximal time shift the service experienced in the past hour.

In some implementations, the service may incorporate management of greedy clients (e.g. progressive download of video over HTTP) where higher efficiency and QoE for the aggregate of users can be obtained by limiting the BW consumed by each stream. This is because in some cases (e.g. TCP) transmission protocol inefficiently grows to high bitrates and then drops to low bitrates when experiencing packet delays/drops. Also in some video transmission systems (e.g. Adaptive streaming or Microsoft Smooth-Streaming) a greedy client will switch to high-bandwidth versions based on momentary availability of bandwidth and will have to switch back to lower quality later on. Maximizing QoE for such cases involves limiting the bandwidth allowed for the stream. When a stream has reached its assigned bandwidth limit, limitation can be strict (strictly delaying transmission of further packets up to never assigning bandwidth) or loose (lowering priority of packets beyond the assigned bandwidth). A consumed bandwidth measurement for applying the limitation can be averaged across time windows which best serve the application. Bandwidth assignment for this purpose can be static or can be updated from time to time, possibly with a gradual formula and preferably in coordination with the same resource manager assigning downstream bandwidth allocation to streams.

In some implementations, if a multiplexer assigns packets one by one according to their order in the output stream and only considers input data that is already due, the lower-priority packets are bound to have a unidirectional time shift—they can only be delayed. Since service tolerance is often bidirectional (allowing at least some tolerance for too-early transmission) it is recommended that the multiplexer works in time-windows where: (i) in each time window, services are scanned in order of priority defined; (ii) per service, input packets are allocated over packets still unpopulated; and (iii) when a due-packet cannot be allocated its exact timing, alternative packet-slots are considered in order by absolute distance from due time such that for example sending it 2 msec-too-early is considered before considering to send it 3-msec-too late. In case tolerance is not symmetrical for delaying and sending too early, the order can be altered accordingly. It should be noted that working in this method of time windows has no impact on processing complexity. It does impact space complexity and size of the time window can be selected accordingly. The size of the time-window is not required to be larger than the timing tolerance of the most robust service.

In still further implementations, data waiting to be transmitted cannot be transmitted within the tolerance defined for this service. It is possible for the multiplexer to decide to drop this data so as to not waste BW for transmission that will provide no benefit to the user. For example, in a service known to consider packets as lost and eligible for retransmission after 100 msec, there is no point sending both instances of the packet. In a low delay voice application, which drops any data that arrives over 50 msec late, there is no point sending such data with a delay larger than 50 msec.

In additional implementations, allocation of services to the channel should be modified such that given the prioritized VBR delivery channel, the best overall users experience is provided given the set of services to be carried and the set of channels available. This can be achieved by an allocation logic which calculates for each channel: (i) the average bandwidth consumed by services allocated to it; (ii) the service-impact-frequency: The expected frequency of an event where in a time window T, the amount of bits to be sent exceeds the channel capacity. T should be the tolerance of the most robust service in the channel. In case the average BW of services having tolerance T is much lower than variability of other (more sensitive) services, allocation logic should also calculate this frequency when disregarding bandwidth of the robust services and when using the value T being the tolerance of the most robust remaining service. Note that this calculation either can be based on by known a-priori characteristics of the bandwidth consumption of each service or by online statistics gathered form equipment processing the traffic (e.g. the channel multiplexers).

It should be understood that allocation should allocate services to channels such that the Expected-Service-impact-frequency on the most loaded channel is minimal. This implies: (i) leveling bandwidth of allocated services across channels; and (ii) leveling across channels the services from each robustness-group so each channel carries services with a variety of timing tolerances. Allocation decisions can also assign or update bandwidth limits or bandwidth guarantees to specific streams.

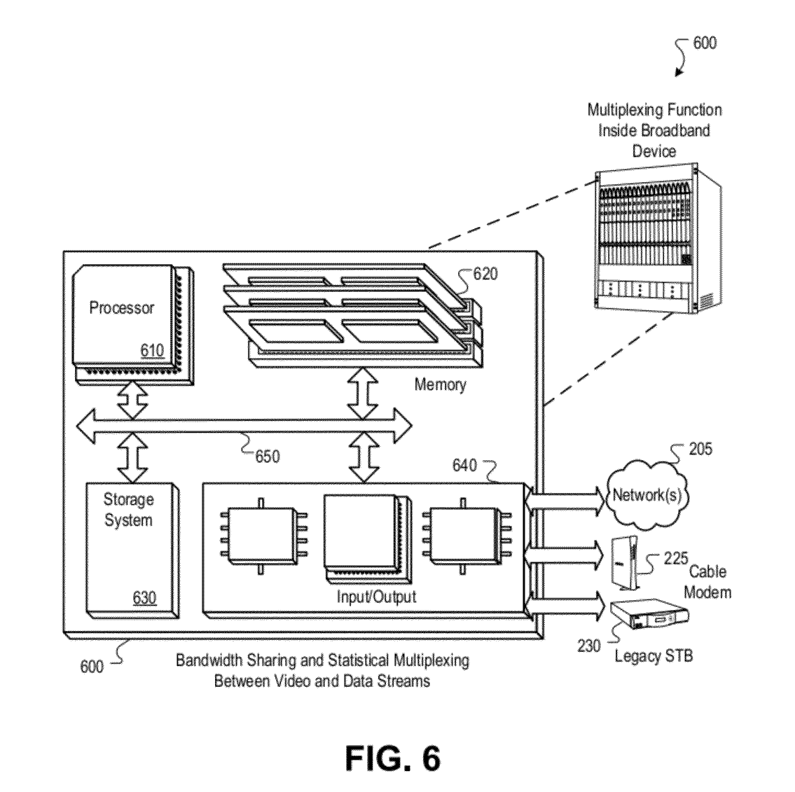

FIG. 6 is a block diagram of a broadband communications device operable to perform bandwidth sharing and statistical multiplexing between video and data streams. The broadband device 600 operable to perform bandwidth sharing and statistical multiplexing between video and data streams can include a processor 610, a memory 620, a storage device 630, and an input/output device 640. Each of the components 610, 620, 630, and 640 can, for example, be interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the device 600. In one implementation, the memory 620 is a computer-readable medium. In one implementation, the memory 620 is a volatile memory unit. In another implementation, the memory 620 is a non-volatile memory unit.

In some implementations, the storage device 630 is capable of providing mass storage for the device 600. In one implementation, the storage device 630 is a computer-readable medium. In various different implementations, the storage device 630 can, for example, include a hard disk device, an optical disk device, flash memory or some other large capacity storage device.

The input/output device 640 provides input/output operations for the device 600. In one implementation, the input/output device 640 can include one or more of a wireless interface, CM 225 (e.g., CM 225 of FIG. 2), legacy STB 230 (e.g., legacy STB 230 of FIG. 2), such as, for example, an IP network interface device, e.g., an Ethernet card, a cellular network interface, a serial communication device, e.g., and RS-232 port, and/or a wireless interface device, e.g., and 802.11 card. In another implementation, the input/output device can include driver devices configured to receive input data and send output data to other input/output devices (e.g., a CM 230 and/or legacy STB 235), as well as sending communications to, and receiving communications from various networks.

The device (e.g., a CMTS) of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, e.g., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

The term “system processor” encompasses all apparatus, devices, and machines for processing data, including by way of example a programmable processor, a computer, or multiple processors or computers. The system processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors (general microprocessors being transformed into special purpose microprocessor through the application of algorithms described herein), and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile communications device, a phone, a cable modem, a set-top box, a mobile audio or video player, or a game console, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing can be advantageous.

What is claimed is:

1. A bandwidth sharing and multiplexing device, comprising:
a network interface operable to receive video transport streams and DOCSIS encapsulated data packet streams;
a processor module operable to perform a multiplexing function on the input streams and further operable to generate an output multiplexed bit stream;
wherein the multiplexing function maintains a time base calculation per input stream;
wherein the multiplexing function handles PSI and PID numbers; and
wherein the network interface is further operable to transmit the output multiplexed bit stream.

2. The bandwidth sharing and multiplexing device of claim 1, wherein the output multiplexed bit stream is allocated to a single output channel.

3. The bandwidth sharing and multiplexing device of claim 1, wherein the output multiplexed bit stream is allocated across multiple output channels.

4. The bandwidth sharing and multiplexing device of claim 1, wherein the video transports stream is ITU H.222.

5. The bandwidth sharing and multiplexing device of claim 3, wherein the video transport streams are any combination of variable bit rate and constant bit rate streams.

6. The bandwidth sharing and multiplexing device of claim 3, wherein the multiplexing function treats input streams as inputs to one larger channel, wherein the larger channel has a bandwidth of all channels belonging to a bonded channel.

7. The bandwidth sharing and multiplexing device of claim 5, wherein the output multiplexed bit stream encapsulates IP sequence numbers.

8. A computer implemented method comprising:
receiving a data or video data packet via an interface;
associating a data or video data packet with a corresponding downstream channel via a processor;
calculating and applying prioritization logic via a processor;
adding a packet data structure to a data packet via a processor;
wherein the prioritization logic is operable to embed data packets into unused video stream channels based upon latency characteristics associated with the data or video data packet; and
wherein the added packet data structure contains timing information to perform multiplexing of received data packets.

9. The computer implemented method of claim 8, wherein prioritization logic calculates an estimated bandwidth parameter.

10. The computer implemented method of claim 8, wherein prioritization logic calculates an estimated quality of service parameter.

11. The computer implemented method of claim 8, wherein prioritization logic calculates an estimated quality of user experience parameter.

12. The computer implemented method of claim 11, wherein timing information includes an MPEG table value.

13. A computer implemented method comprising:
receiving data and video data packets via an interface;
iterating in order of priority over data and video data packet candidates for transmission over an interval T via a processor;
marking a set of packets to be transmitted over the interval T for each channel C via a processor;
summing up set of packets to channel C capacity via a processor;
postponing remaining packets to next interval via a memory buffer;
calculating a transmission time based on timing requirements for each packet via a processor; and
processing packets per channel C in order of transmission time via a processor.

14. The computer implemented method of claim 13, wherein excess packets that exceed the channel C capacity within the interval T are stored in a memory for subsequent processing.

15. The computer implemented method of claim 13, wherein channel C is compatible with both DOCSIS Cable Modems and MPEG Set-top boxes.

16. The computer implemented method of claim 13, wherein statistical multiplexing and rate shaping are applied prior to transmitting packets.
